(19) United States
(12) Patent Application Publication
(10) Pub. No.: US 2021/0286302 A1
(43) Pub. Date: Sep. 16, 2021

(54) IMAGING SYSTEM

(71) Applicant: HEWLETT-PACKARD DEVELOPMENT COMPANY, L.P., Spring, TX (US)

(72) Inventor: Takeshi KAWAMURA, Yokohama (JP)

(21) Appl. No.: 17/258,117

(22) PCT Filed: Oct. 16, 2019
(86) PCT No.: PCT/US2019/056457

§ 371 Date: Jan. 5, 2021

(30) Foreign Application Priority Data
Oct. 29, 2018 (JP) 2018-202976

(51) Int. Cl. G03G 15/20

(52) U.S. Cl. CPC G03G 15/2053; G03G 15/2064

(57) ABSTRACT

An imaging system includes a heating member to heat a printing medium that contains a toner, and a pressing member to press the printing medium against the heating member in a nip region in which the toner is fixed. A housing accommodates the heating member and the pressing member, and includes a printing medium ejection port to eject the printing medium which passes through the nip region. A duct includes an inlet located between the nip region and the printing medium ejection port, and an outlet located inside the housing, to remove water vaper. The inlet is located in a guide member that extends toward the printing medium ejection port from the heating member side of the nip region

### BACKGROUND

An image forming device may include a fixing device that fixes a toner image to a printing medium. The fixing device includes an endless belt that conveys a fixing target printing medium, a heating roller that heats the endless belt, and a pressing roller that presses the endless belt against the heating roller. A duct is located on an upper side of the fixing device, and a water vapor flows into the duct toward the upper side. The duct includes a plurality of flow passages which extend to the outside of a housing, and the water vapor that flows into the duct is discharged to the outside of the device through the duct.

### BRIEF DESCRIPTION OF THE DRAWINGS

FIG. 1 is a schematic view illustrating an example imaging system.

FIG. 2 is a cross-sectional view schematically illustrating an example fixing device of an imaging system and a conveying route of a printing medium.

FIG. 3 is a cross-sectional view illustrating an example housing of a fixing device.

FIG. 4 is a perspective view illustrating an example duct that is located inside a fixing device.

FIG. 5 is a perspective view illustrating an example duct.

FIG. 6 is a perspective view illustrating an example duct which does not include a flow passage formed member.

FIG. 7 is a perspective view illustrating another example duct.

FIG. 8 is a graph illustrating an example relationship between a total area of a hole portion in an inlet of the duct and a maximum humidity.

FIG. 9A, FIG. 9B, and FIG. 9C are views schematically illustrating condensation that adheres to a printing medium.

FIG. 10 is a graph illustrating an example humidity measurement.

FIG. 11 is a graph illustrating additional example humidity measurements.

### DETAILED DESCRIPTION

In the following description, with reference to the drawings, the same reference numbers are assigned to the same components or to similar components having the same function, and overlapping description is omitted. The drawings may be simplified or exaggerated for further clarification of examples. An example imaging system may be a fixing device, a printer, a developing device, or a component thereof.

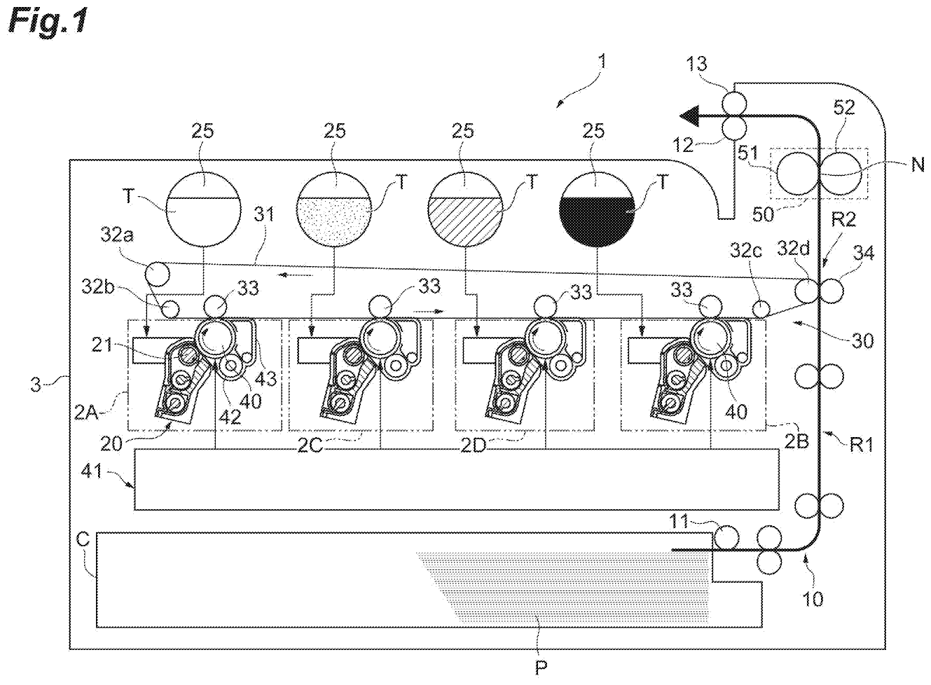

As illustrated in FIG. 1, an example imaging system 1 may be configured to form a color image by using respective colors of yellow, magenta, cyan, and black. The imaging system 1 may include a recording medium conveying device 10, a transfer device 30, a fixing device 50, and first to fourth stations 2A, 2B, 2C, and 2D. Each of the stations 2A, 2B, 2C, and 2D includes a developing device 20 and a photoconductor 40.

The recording medium conveying device 10 conveys a printing medium P, such as paper. In some examples, the recording medium conveying device 10 includes a paper feeding roller 11 that conveys the printing medium P on which an image is formed along a conveying route R1. The printing medium P is stacked and stored in a cassette C, and is picked up by the paper feeding roller 11 to be conveyed. The paper feeding roller 11 may be located in the vicinity of an outlet of the printing medium P in the cassette C. The printing medium P may arrive, via the recording medium conveying device 10, at a secondary transfer region R2 through the conveying route R1 at a timing at which a toner image to be transferred arrives at the secondary transfer region R2.

The transfer device 30 secondarily transfers the toner image onto the printing medium P. The fixing device 50 fixes the toner image to the printing medium P. For example, the transfer device 30 receives a toner from each of the stations 2A to 2D to form the toner image (stacked toner image). In some examples, the transfer device 30 includes a transfer belt 31, suspension rollers 32a, 32b, 32c, and 32d, primary transfer rollers 33, and a secondary transfer roller 34.

The transfer belt 31 may be suspended by the suspension rollers 32a to 32d. In some examples, the primary transfer rollers 33 are provided in correspondence with the stations 2A to 2D. Each of the primary transfer rollers 33 presses against, sandwiches or otherwise engages the transfer belt 31 in combination with the photoconductor 40 of each of the stations 2A to 2D. The secondary transfer roller 34 similarly presses against, sandwiches or otherwise engages the transfer belt 31 in combination with the suspension roller 32d. The transfer belt 31 may comprise an endless belt that is circulated by the suspension rollers 32a to 32d. Each of the primary transfer rollers 33 presses against the photoconductor 40 from an inner peripheral side of the transfer belt 31. The secondary transfer roller 34 presses against the suspension roller 32d from an outer peripheral side of the transfer belt 31.

In some examples, the fixing device 50 fixes a toner image, which is secondarily transferred onto the printing medium P from the transfer belt 31, to the printing medium P. The fixing device 50 may include a heating member 51 that heats the printing medium P and fixes the toner image to the printing medium P, and a pressing member 52 that presses the heating member 51. The heating member 51 and the pressing member 52 may be formed in a cylindrical shape in combination with each other. A nip region N that is a fixing region of the printing medium P is located between the heating member 51 and the pressing member 52. When the printing medium P passes through the nip region N, the toner image is heated and fixed, e.g., fused, to the printing medium P.

Each of the stations 2A to 2D may comprise a process cartridge including the developing device 20, the photoconductor 40, a charging device 42, and a cleaning device 43 in an integral manner. In some examples, the imaging system 1 includes a housing 3 to which the stations 2A to 2D are mounted. Additionally, the stations 2A to 2D may be detachable manner with respect to the housing 3 by opening the door of the housing 3, and being inserted into and extracted from the housing 3.

Each of the first to fourth stations 2A to 2D may be provided for every color of a toner T. In each of the first to fourth stations 2A to 2D, the photoconductor 40 forms an electrostatic latent image, and the developing device 20 develops the electrostatic latent image that is formed on the photoconductor 40. The photoconductor 40 may be a photoconductive drum, and may be an organic photoconductor (OPC). In some examples, the first to fourth stations 2A to 2D are arranged in line along a movement direction of the transfer belt 31. One or more of the developing device 20, an exposure unit 41, the charging device 42, and the cleaning device 43 may face an outer peripheral surface of the photoconductor 40.

The charging device 42 may be configured to uniformly charge the outer peripheral surface of the photoconductor 40 to a predetermined potential. In some examples, the charging device 42 is a charging roller that rotates in conformity to rotation of the photoconductor 40. The exposure unit 41 exposes the outer peripheral surface of the charged photoconductor 40 which is charged by the charging device 42 in correspondence with an image that is formed on the printing medium P. A potential of a portion of the peripheral surface of the photoconductor 40 that is exposed to the exposure unit 41 varies, and thus an electrostatic latent image is formed on the outer peripheral surface of the photoconductor 40.

In some examples, a toner tank 25 faces each of the stations 2A to 2D. The toner T is supplied from the toner tank 25 to the developing device 20 of each of the stations 2A to 2D. The developing device 20 develops an electrostatic latent image on an outer peripheral surface of the photoconductor 40 by the toner T that is supplied to form a toner image. The photoconductor 40 may comprise an image carrier on which the toner image is formed.

The developing device 20 receives a developing voltage, and supplies the toner T to the photoconductor 40 in correspondence with the developing voltage. The toner image formed on the outer peripheral surface of the photoconductor 40 is initially transferred to the transfer belt 31. In some examples, the transfer belt 31 may be an image carrier on which the toner image is formed. The toner T that remains on the outer peripheral surface of the photoconductor 40 after the initial transfer is removed by the cleaning device 43.

The developing device 20 of each of the stations 2A to 2D includes a developing roller 21 that enables the photoconductor 40 to carry a toner. In some examples, a toner and a carrier may be adjusted to a predetermined mixing ratio, and a developer that includes the toner and the carrier is mixed and stirred to uniformly disperse the toner. The developer is carried by the developing roller 21, and the developing roller 21 rotates to convey the developer to a region that faces the photoconductor 40. In addition, the toner in the developer carried by the developing roller 21 moves to the electrostatic latent image of the photoconductor 40, and the electrostatic latent image is developed.

An example imaging method that may be performed by the imaging system 1 is described with reference to FIG. 1. The example method may comprise a printing process of the imaging system 1. When an image signal of an image to be recorded is input to the imaging system 1, the paper feeding roller 11 rotates to pick up the printing medium P staked in the cassette C, and the printing medium P is conveyed along the conveying route R1. The charging device 42 uniformly charges the outer peripheral surface of the photoconductor 40 to a predetermined potential. In addition, the exposure unit 41 irradiates the outer peripheral surface of the photoconductor 40 with laser light on the basis of the image signal to form an electrostatic latent image on the outer peripheral surface of the photoconductor 40.

Next, the developing device 20 performs development by forming a toner image on the photoconductor 40. In each of the stations 2A to 2D, a toner image may be initially transferred to the transfer belt 31 from the photoconductor 40 in a region in which the photoconductor 40 and the transfer belt 31 face each other. Toner images formed by the photoconductors 40 of the first to fourth stations 2A to 2D are sequentially superimposed on the transfer belt 31 to form one composite toner image. The composite toner image is secondarily transferred to the printing medium P conveyed from the recording medium conveying device 10 in a secondary transfer region R2 in which the suspension roller 32d and the secondary transfer roller 34 face each other.

The printing medium P to which the composite toner image is secondarily transferred is conveyed from the secondary transfer region R2 to the fixing device 50. For example, the fixing device 50 fuses or otherwise fixes the stacked toner image to the printing medium P by enabling the printing medium P to pass through the nip region N while applying heat and pressure to the printing medium P. In some examples, the printing medium P to which the composite toner image is heated and fixed is ejected to the outside of the imaging system 1 by ejection rollers 12 and 13.

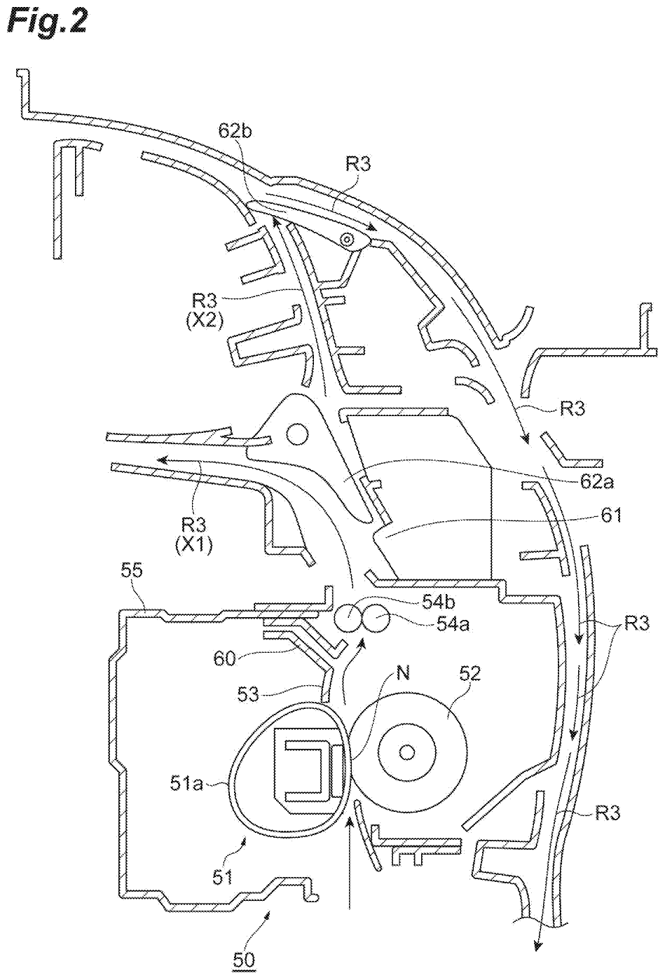

FIG. 2 is an example cross-sectional view illustrating the fixing device 50 and a conveying route R3 of the printing medium P that extends downstream of the fixing device 50 (e.g., an upper side). In some examples, the heating member 51 includes a heating belt 51a, the printing medium P is placed on the heating belt 51a, and the printing medium P is heated. Furthermore, the heating member 51 may be a rigid body. The above-described nip region N is formed between the heating member 51 and the pressing member 52, and the nip region N is formed by a contact pressure that operates between the heating member 51 and the pressing member 52. In some examples, the pressing member 52 comprises a pressing roller that is set to a roll shape, but in other examples the pressing member 52 may not have a roll shape.

The fixing device 50 may include the heating member 51 and the pressing member 52 described above, a guide member 53 that guides the printing medium P, a pair of conveying rollers 54a and 54b through which the printing medium P guided by the guide member 53 passes, and a duct 60 that extends from the guide member 53. In addition, the fixing device 50 may include a housing 55 that accommodates or houses the heating member 51, the pressing member 52, the guide member 53, the conveying rollers 54a and 54b, and the duct 60.

In some examples, a chute 61 that guides the printing medium P ejected from the housing 55, and switching members 62a and 62b which switch a conveying direction of the printing medium P may be located in the conveying route R3 of the printing medium P. When single-sided printing of the printing medium P is performed, the switching member 62a switches the conveying route of the printing medium P to a direction X1 toward the outside of the imaging system 1. In some examples, printing of the printing medium P relates to a first surface of double-side printing, and the switching member 62a switches the conveying route of the printing medium P to a direction X2 that is different from the direction X1. The printing medium P that is conveyed to the direction X2 may be switched back from the switching member 62b and may be turned over. The printing medium P may again move to the secondary transfer region R2, and printing is performed with respect to a second surface in the secondary transfer region R2. After that the printing medium P passes through the fixing device 50 and the switching member 62a, moves in the direction X1, and is ejected outside of the imaging system 1.

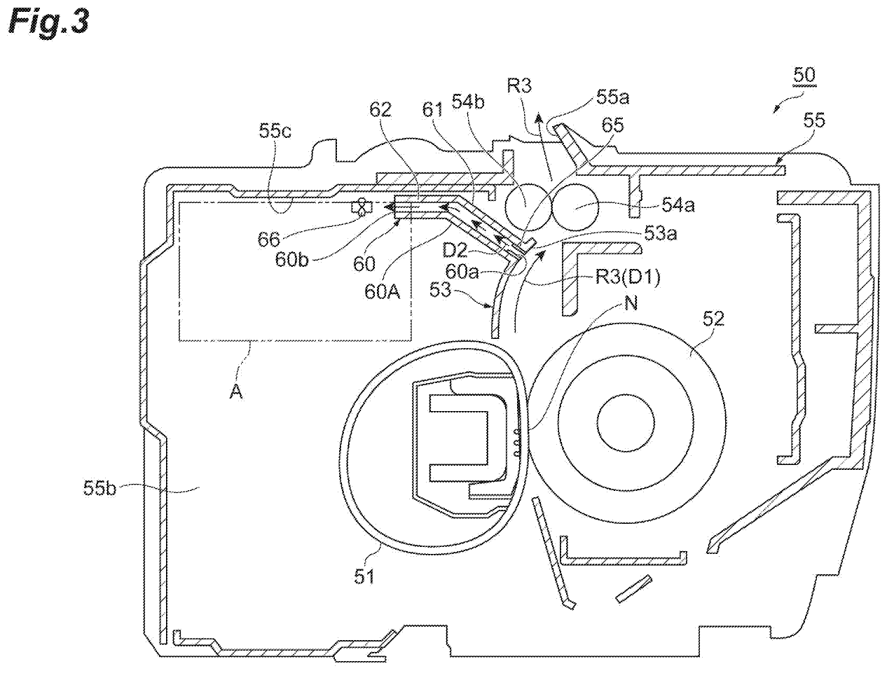

FIG. 3 is a cross-sectional view illustrating the fixing device 50. As illustrated in FIG. 3, the example guide member 53 is located on an upward side (with respect to gravity) of the nip region N, which is located between the heating member 51 and the pressing member 52, and may be located on a vertically upward side or an obliquely upward side of the nip region N. In some examples, the guide member 53 guides the printing medium P, which passes through the nip region N, to the vertically upward side or the obliquely upward side. The conveying rollers 54a and 54b are located on an upward side of the guide member 53 and on a lower side of a printing medium ejection port 55a of the housing 55. For example, the printing medium ejection port 55a of the housing 55 is located on an upper end of the housing 55, and is set as an ejection port of the printing medium P.

In the conveying route R3 of the printing medium P in the fixing device 50, the chute 61, and the switching member 62a described above, condensation such as condensed dew may adhere to the conveying route R3 due to water vapor that is generated from the printing medium P and the like. A generation source of the water vapor may include the printing medium P that has passed through the nip region N. The water vapor may be lighter than air such that it is likely to rise. Accordingly, the water vapor generated from the printing medium P, which has passed through the nip region N set to a particular temperature, moves upward, and is cooled down to condensed dew. As a result, condensation may occur in the conveying route R3 at a position higher than the nip region N, that is, downstream of the fixing device 50 and on an upper side thereof.

In some examples, when a power supply of the imaging system 1 is turned ON in a low-temperature environment, dew condensation may occur in the vicinity of the chute 61 and the switching member 62a. When the dew condensation occurs, resistance of the printing medium P varies, and this variation has an effect on the transfer or fixing of a toner image with respect to the printing medium P, and thus may impact image quality. When dew condensation occurs in the conveying route R3, a water drop may adhere to the guide member 53, a water content rate partially varies in the printing medium P that has passed through the guide member 53 to which the water drop adheres, and thus resistance of the printing medium P may vary. Accordingly, to prevent occurrence of dew condensation in the conveying route R3 of the printing medium P, the water vapor that flows along the conveying route R3 of the printing medium P may be reduced.

The example duct 60 may include a flow passage that guides water vapor inside the fixing device 50 in a direction away from the conveying route R3 of the printing medium P, and the flow passage of the duct 60 is formed by a flow passage formed member 60A that extends from the guide member 53. The guide member 53 may extend from the heating member 51 side of the nip region N (the left in FIG. 3) toward the printing medium ejection port 55a. In some examples, the duct 60 extends from the guide member 53 to an empty region A at the inside 55b of the housing 55. An inlet 60a of the duct 60 may be located in the guide member 53. Additionally, the inlet 60a of the duct 60 may be located on an upward side of the nip region N, and an outlet 60b of the duct 60 faces the empty region A at the inside 55b of the housing 55. The outlet 60b faces a direction different from that of the printing medium ejection port 55a.

In some examples, the housing 55 is set to a rectangular box shape, and the empty region A is a region at the inside 55b of the housing 55 in which components are not located. The empty region A may be located at a corner portion at the inside 55b of the housing 55, and may comprise a region including an upper end and one end at the inside 55b. In some examples, the empty region A is effectively used as a space for discharging a water vapor. During a printing operation, a temperature of the nip region N may be between 120° C. to 180° C., and a temperature of the inlet 60a of the duct 60 may be 60° C. or higher.

The dew condensation may occur when moisture in the air reaches a dew-point temperature or, in some cases, a lower temperature. The amount of moisture that occurs from the printing medium P becomes approximately 0.2 g/m³ based on a relationship between a water content of the printing medium P and a basis weight of the printing medium P when the water content of the printing medium P before and after the fixing is assumed to be 8% →6%. Based on a relationship curve between the dew-point temperature and the atmospheric temperature, under a low-temperature and low-humidity condition at which dew condensation is likely to occur, a temperature at which dew condensation occurs may be 55° C. or lower. In an experiment using an imaging apparatus, dew condensation significantly occurred under the condition of 55° C. or lower. Under the condition, to mitigate dew condensation, the inlet 60a of the duct 60 was located at a position that reaches 60° C. or higher, and water vapor was efficiently recovered from the inlet 60a,

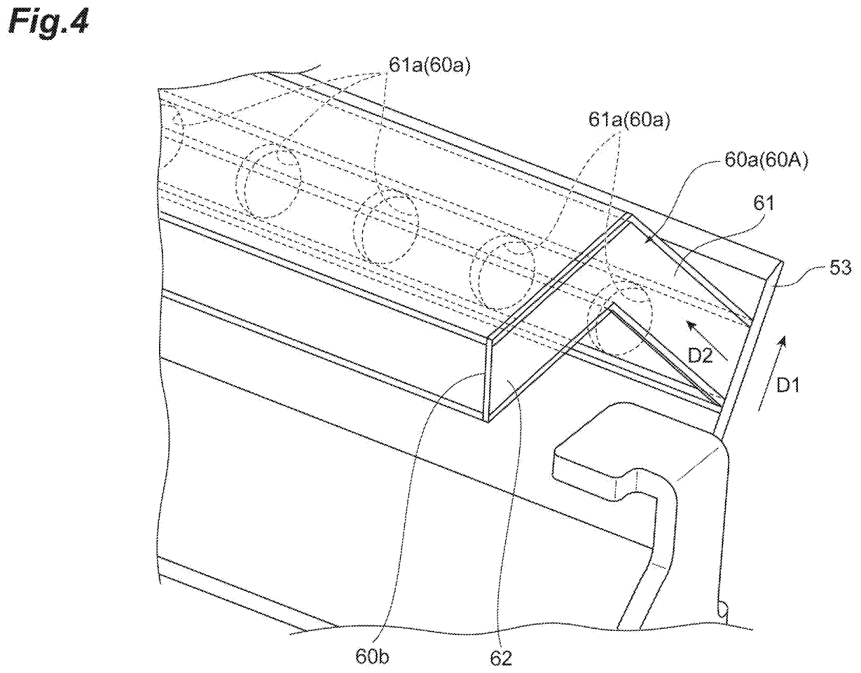

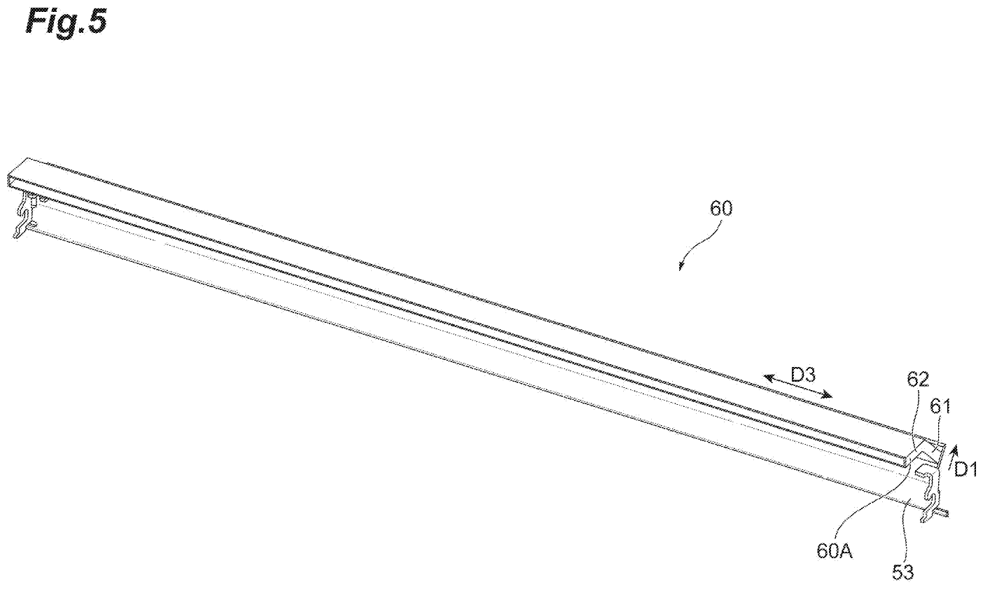

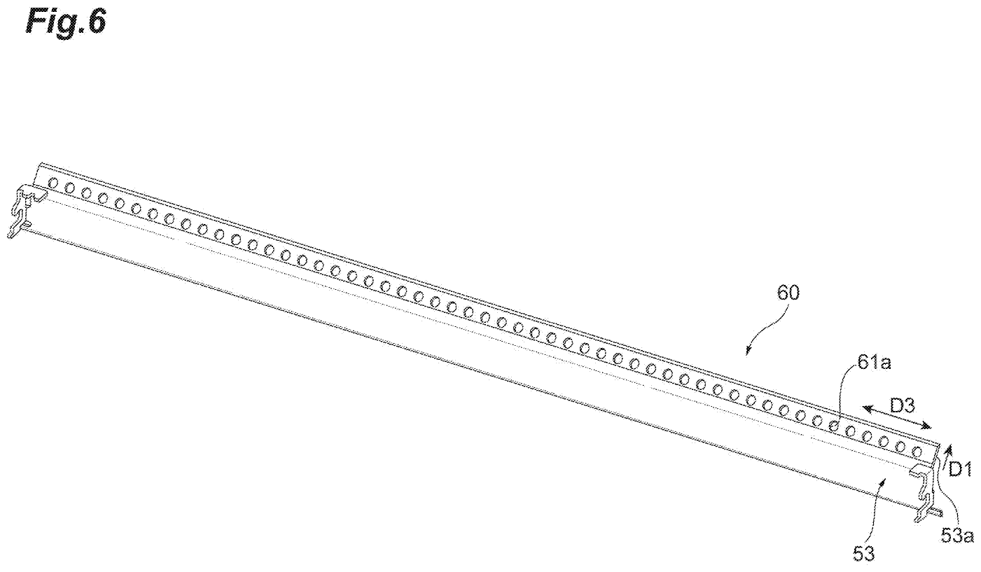

FIG. 4 is a perspective view illustrating the guide member 53 and the duct 60. FIG. 5 is a perspective view illustrating the duct 60. FIG. 6 is a perspective view illustrating an example state in which the flow passage formed member 60A is removed from the duct 60. As illustrated in FIG. 4, FIG. 5, and FIG. 6, the duct 60 may include a first flow passage 61 including a hole portion 61a which extends from the guide member 53 and through which a water vapor passes, and a second flow passage 62 that extends from a side, which is opposite to the guide member 53, of the first flow passage 61 toward the empty region A. In some examples, the hole portion 61a corresponds to the inlet 60a of the duct 60 described above.

The first flow passage 61 may extend in a direction D2 that is different from a conveying direction D1 of the printing medium P in which the guide member 53 guiding the printing medium P extends. In some examples, the guide member 53 extends upward in a state of being inclined to the right with respect to the nip region N, and the first flow passage 61 extends upward in a state of being inclined to the left with respect to the nip region N. Furthermore, the first flow passage 61 may extend upward in a state of being inclined to the right with respect to the nip region N, and the guide member 53 may extend upward in a state of being inclined to the left with respect to the nip region N. In this manner, the direction in which the guide member 53 and the first flow passage 61 extend may vary. In addition, the position of the duct 60 may be set to a location that faces the heating member 51 (see FIG. 2), but the duct may be provided at a location that also faces the pressing member 52 in addition to the duct 60 to effectively recover water vapor.

As illustrated in FIG. 5 and FIG. 6, the duct 60 may comprise an elongated shape that extends in a direction D3 that intersects the conveying direction D1 of the printing medium P. The direction D3 may correspond to a longitudinal direction of the printing medium P. In some examples, the first flow passage 61 includes a plurality of the hole portions 61a along the direction D3 that is the longitudinal direction of the duct 60. The hole portions 61a may be set to a circular shape. However, the hole portions 61a may be set to a rectangular shape, and the like, and the shape of the hole portion 61a may be changed. The hole 61a may comprise a tear-shaped hole or an aperture hole. The shape of the holes 61a may be set to a shape in which clogging of the printing medium P is less likely to occur.

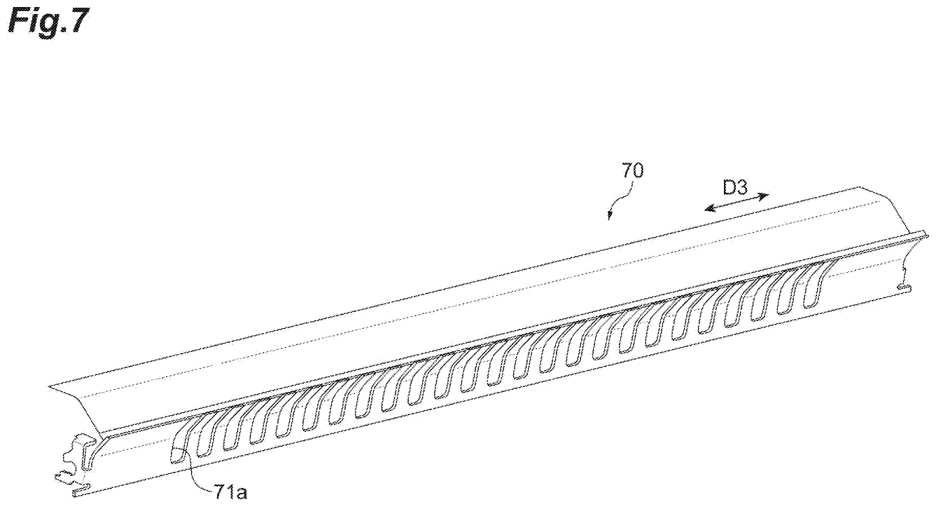

FIG. 7 illustrates an example duct 70 in which a hole portion 71a may set to a rectangular shape similar to the duct 70. In water vapor which passes through the conveying route R3, the water vapor that passes an end (on both end sides) of the duct 70 in the direction D3 is likely to flow out from another portion, and thus dew condensation is less likely to occur. In contrast, water vapor that passes through the vicinity of the center of the duct 70 in the direction D3 is less likely to flow out from another portion, and thus dew condensation is more likely to occur. Accordingly, among a plurality of the holes 71a which are arranged in the direction D3, and in a case where a hole portion 71a located in the vicinity of the center in the direction D3 is greater than a hole portion 71a located at the end in the direction D3, the water vapor which passes through the vicinity of the center in the direction D3 may effectively pass through the hole portion 71a. As a result, the dew condensation prevention effect becomes more significant, similar to the above-described duct 60.

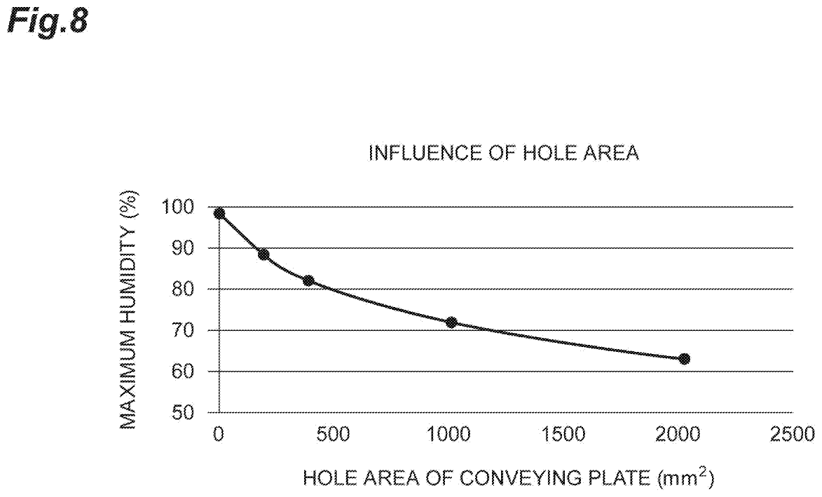

FIG. 8 is a graph illustrating an example relationship between a total area of the hole portions 61a of the duct 60, and a maximum humidity. The total area of the hole portions 61a may be 2000 mm² or greater. In some examples, as illustrated in FIG. 8, more water vapor may flow into the hole portions 61a such that the maximum humidity may be reliably set to 70% or less. As a result, a dew condensation reduction effect may be enhanced. This is also true of the hole portions 71a of the duct 70.

In some examples, a plurality of hole portions 61a having a lattice shape may be formed in a guide surface 53a (refer to FIG. 3) of the guide member 53 that faces the printing medium P in the first flow passage 61. In addition, the plurality of hole portions 61a (inlet 60a) may be arranged in the guide surface 53a in a dispersive manner. Here, “the configuration in which a plurality of hole portions are arranged in a dispersive manner” may be understood to represent one or more of the following states: a state in which the plurality of hole portions 61a are arranged in the guide surface 53a, a state in which the plurality of hole portions 61a are arranged in a lattice shape, and a state in which the plurality of hole portions 61a are arranged in a zigzag shape. Additionally, the plurality of hole portions 61a may be arranged with regular intervals in the direction D3.

The second flow passage 62 may extend from the first flow passage 61 toward the empty region A. In some examples, the second flow passage 62 may extend to be inclined with respect to the first flow passage 61, or may be bent with respect to the first flow passage 61. The second flow passage 62 may extend along an inner surface 55c (refer to FIG. 3) of the housing 55, and a gradient of the second flow passage 62 may be gentler than a gradient of the first flow passage 61. In addition, the second flow passage 62 may extend to be parallel to the inner surface 55c.

As illustrated in FIG. 3, the duct 60 may include a water absorbing member 65. The water absorbing member 65 may comprise a sponge-like member that absorbs moisture, such as a soft foamed sponge member. A material of the water absorbing member 65 may contain a high molecular polymer, such as a water absorptive resin. In some examples, the water absorbing member 65 may be located along an inner surface of the duct 60 (such as first flow passage 61), and may absorb moisture such as condensed dew that occurs at the inside of the duct 60.

The fixing device 50 may include a fan 66 that suctions a water vapor. The fan 66 may be located at a position that faces the output 60b of the duct 60. In some examples, at least one of the water absorbing member 65 and the fan 66 described above may be omitted.

The fixing device 50 may include the duct 60 having the inlet 60a that is located between the nip region N and the printing medium ejection port 55a, and the outlet 60b that is located at a position at the inside 55b of the housing 55. Water vapor may be removed from the printing medium P and the conveying route R3 through the duct 60. Accordingly, dew condensation may be less likely to occur in the printing medium P and the conveying route R3, as described below in further detail.

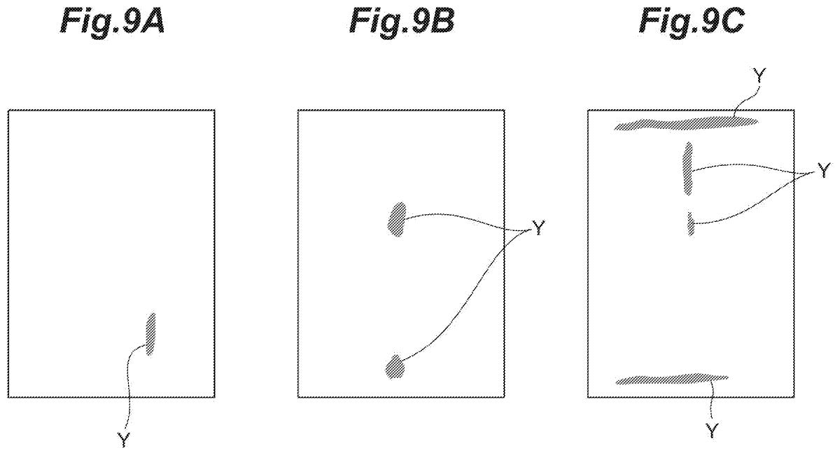

When the power supply of the imaging system 1 is turned ON under a low-temperature environment, dew condensation may occur in the vicinity of the chute 61 and the switching member 62a, and the dew condensation may be likely to occur when the printing speed is fast. In some examples, the imaging system 1 performs printing at a speed of 50 sheets (50 ppm) to 80 sheets (80 ppm) per minute. FIGS. 9A to 9C illustrate an example test result when performing printing with an imaging system according to a comparative example which does not include a duct 60. FIG. 9A illustrates dew condensation Y that occurs in the printing medium P when performing printing at 60 ppm, FIG. 9B illustrates dew condensation Y that occurs in the printing medium P when performing printing at 70 ppm, and FIG. 9C illustrates dew condensation Y that occurs in the printing medium P when performing printing at 80 ppm. As illustrated in FIG. 9A to FIG. 9C, it can be seen that a faster printing speed may result in a greater amount of dew condensation Y.

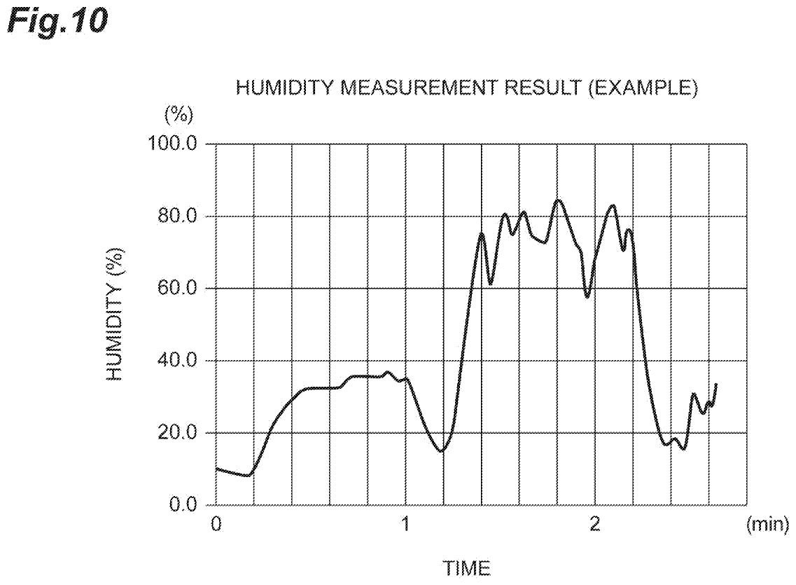

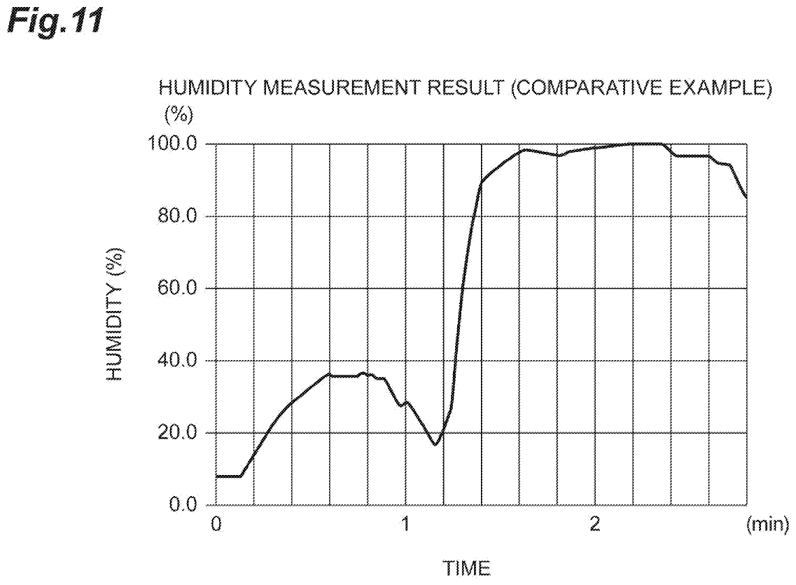

In some examples, the concentration of dew that would otherwise adhere to the printing medium P may be suppressed. As illustrated in FIG. 10 and FIG. 11, the imaging system 1 including the example duct 60 may be configured to lower humidity and to suppress the occurrence of dew condensation in comparison to the comparative example in which a duct is not provided.

FIG. 10 is a graph illustrating example time-series data of humidity in the imaging system including the duct 60. FIG. 11 is a graph illustrating example time-series data of humidity in the imaging system that does not includes the duct according to the comparative example. In the graphs illustrated in FIG. 10 and FIG. 11, the vertical axis represents humidity that is measured by a hygrometer, and the horizontal axis represents time from a time at which the power supply is turned ON. Furthermore, the hygrometer is located inside the chute 61, and printing was stopped after printing 50 sheets for one minute with respect to the printing medium P.

As illustrated in FIG. 10 and FIG. 11, humidity increased in the example and the comparative example after printing approximately 10 sheets after the power supply was turned ON. When one minute had passed after the power supply was turned ON and printing of 50 sheets was terminated, humidity was approximately 30% to 40% in both the example and the comparative example. After 50 sheets were printed, the humidity lowered and then rose in both the example and the comparative example. In addition, after approximately 1.5 minutes passed after the power supply was turned ON, humidity reached 100% in the comparative example, and dew condensation occurred in the vicinity of the chute 61. In contrast, in the example in which the duct 60 is provided, humidity rapidly rose after approximately 1.5 minutes passed after the power supply was turned ON, but humidity did not reach 100%, and dew condensation did not occur. The upper limit of humidity in the example was approximately 80%. Accordingly, humidity in the example in which the duct 60 is provided may be reduced in comparison to the comparative example in which the duct is not provided, and thus dew condensation may also be suppressed.

As illustrated in FIG. 3, the inlet 60a of the duct 60 may be located at a position that is higher than or above the nip region N. In some examples, water vapor may be guided from the nip region N to the inlet 60a to more effectively remove the water vapor from the printing medium P and the conveying route R3.

The outlet 60b of the duct 60 may face a direction different from that of the printing medium ejection port 55a. In some examples, the outlet 60b may face a side opposite to the printing medium ejection port 55a. The water vapor that is discharged from the outlet 60b may be separated from the printing medium ejection port 55a to more reliably suppress occurrence of dew condensation in the printing medium P and the conveying route R3. In addition, the duct 60 may extend in the direction D2 to direct the water vapor away from the conveying direction D1 in which the printing medium P is conveyed. The water vapor may be guided in the direction D2 to separate the water vapor from the printing medium P.

The duct 60 may include a plurality of inlets 60a (hole portions 61a), and the plurality of inlets 60a may be located in line along the direction D3 that is a longitudinal direction of the duct 60. In some examples, the plurality of inlets 60a are located in line along the direction D3 to introduce a water vapor from each of the plurality of inlets 60a to the inside of the duct 60. In addition, an area of each of the inlets 60a may be decreased so that the printing medium P that passes through the guide member 53 is not caught in the inlets 60a.

The duct 60 may be formed integrally with the guide member 53 that guides the printing medium P to help reduce the number of parts. In addition, the guide member 53 may provide a function of guiding the printing medium P and a function of removing the water vapor.

The second flow passage 62 of the duct 60 may be bent in a direction along the inner surface 55c of the housing 55 with respect to the first flow passage 61. In some examples, a flow passage of the water vapor may conform to the inner surface 55c of the housing 55 so that the water vapor may not be directly sprayed to the inner surface 55c. The outlet 60b of the duct 60 may face the empty region A at the inside 55b of the housing 55. The empty region A at the inside 55b of the housing 55 may be used as a water vapor discharging portion.

The fixing device may further include the water absorbing member 65 that is located on the inner surface of the duct 60 and absorbs moisture. When water vapor flows into the duct 60 and dew condensation occurs at the inside of the duct 60, the water absorbing member 65 can absorb the moisture reduce, suppress or eliminate moisture from returning to the printing medium P and the conveying route R3. The water absorbing member 65 may be located in the first flow passage 61 that is inclined in order to reliably absorb moisture that flows down.

The inlet 60a of the duct 60 may be located at a site that reaches 60° C. or higher. The inlet 60a of the duct 60 may be located immediately above the nip region N. In some examples, “immediately above” may be understood as immediately above the side of the nip region N, such that an additional part is not provided between the nip region N and the inlet 60a. Water vapor that occurs in the nip region N to the duct 60 may be immediately guided away to provide a dew condensation countermeasure. The fixing device 50 may further include the fan 66 located at a position that faces the outlet 60b of the duct 60 to increase the suction power of the water vapor to the duct 60. However, even examples which do not include the fan 66 may perform removal of the water vapor from the printing medium P and the conveying route R3.

It is to be understood that not all aspects, advantages and features described herein may necessarily be achieved by, or included in, any one particular example. Indeed, having described and illustrated various examples herein, it should be apparent that other examples may be modified in arrangement and detail.

For example, in addition to the examples in which the printing medium ejection port 55a is located at an upper end of the housing 55, the printing medium ejection port 55a may be located in a lateral surface or a lower surface of the housing 55. In some examples, the conveying route R3 of the printing medium P extends upward from the fixing device 50, but a direction of the conveying route R3 of the printing medium P may also extend in other directions.

1. An imaging system, comprising:
a heating member to heat a printing medium that contains a toner;
a pressing member to press the printing medium against the heating member in a nip region in which the toner is fixed;
a housing that accommodates the heating member and the pressing member, and includes a printing medium ejection port to eject the printing medium which passes through the nip region; and
a duct that includes an inlet located between the nip region and the printing medium ejection port, and an outlet located inside the housing, to remove water vapor,
wherein the inlet is located in a guide member that extends toward the printing medium ejection port from the heating member side of the nip region.

2. The imaging system according to claim 1,
wherein the inlet of the duct is located at a position that is higher than the nip region.

3. The imaging system according to claim 1,
wherein the outlet of the duct faces a direction different from a direction of the printing medium ejection port.

4. The imaging system according to claim 1,
wherein the duct extends away from a direction in which the printing medium is conveyed.

5. The imaging system according to claim 1,
wherein the duct includes a plurality of inlets, and
the plurality of inlets are located in line along a longitudinal direction of the duct.

6. The imaging system according to claim 1,
wherein the inlet has a circular shape.

7. The imaging system according to claim 1,
wherein the duct is formed integrally with the guide member.

8. The imaging system according to claim 1,
wherein the duct includes a first flow passage that obliquely extends upward from the guide member, and a second flow passage that obliquely extends with respect to the first flow passage.

9. The imaging system according to claim 8,
wherein the first flow passage extends in a direction different from a direction in which the printing medium guided by the guide member is conveyed.

10. The imaging system according to claim 8,
wherein the second flow passage is bent in a direction conforming to an inner surface of the housing with respect to the first flow passage.

11. The imaging system according to claim 1,
wherein the outlet of the duct faces an empty region at the inside of the housing.

12. The imaging system according to claim 1, comprising:
a water absorbing member that is located on an inner surface of the duct.

13. The imaging system according to claim 1,
wherein the inlet of the duct is located immediately above the nip region.

14. The imaging system according to claim 1,
wherein the inlet of the duct is positioned at a location that reaches a temperature of 60° C. or higher.

15. The imaging system according to claim 1, comprising:
a fan that faces the outlet of the duct.
